(19) United States
(12) Patent Application Publication
(10) Pub. No.: US 2016/0140761 A1
(43) Pub. Date: May 19, 2016

(54) USING DEPTH INFORMATION FOR DRAWING IN AUGMENTED REALITY SCENES

(71) Applicant: Microsoft Technology Licensing, LLC., Redmond, WA (US)

(72) Inventors: Justin Saunders, Kirkland, WA (US); Doug Berrett, Seattle, WA (US); Jeff Henshaw, Redmond, WA (US); Matthew Cooper, Issaquah, WA (US); Michael Palotas, Seattle, WA (US)

(21) Appl. No.: 14/547,619

(22) Filed: Nov. 19, 2014

(51) Int. Cl. G06T 19/00; G06T 17/20; G06F 3/01

(52) U.S. Cl. CPC G06T 19/006; G06F 3/011; G06T 17/205; G06T 2207/10028

(57) ABSTRACT

Optimizing augmented reality scenes by using depth information to accurately display interactions between real objects and synthetic objects is described. A stream of depth data associated with a real scene of an augmented reality display and a stream of color data associated with the real scene may be received. The stream of depth data may be processed to construct a first mesh and the first mesh may be projected into a color space associated with the stream of color data to construct a second mesh. In some examples, a position of the synthetic objects respective to real objects in the real scene may be determined and/or queries may be conducted to determine how the synthetic objects interact with the real objects in the real scene. Based at least on constructing the second mesh, determining positions, and/or conducting queries, one or more synthetic objects may be drawn into the real scene.

### BACKGROUND

Augmented reality is a technology that supplements a display of physical, real-world objects in a scene with computer-generated input such as sound, video, graphics, GPS, etc. For example, video games may supplement live video of real objects with virtual game characters and objects. Current techniques draw virtual objects on top of physical, real-world scenes. As a result, all of the synthetic objects appear as flat objects that do not interact with the scene and/or objects in the scene. Other techniques employ computer vision techniques to generate depth maps of physical, real-world scenes. These techniques are computationally expensive. As a result, current techniques result in poor user experience.

### SUMMARY

Techniques for optimizing augmented reality scenes by using depth information to accurately display interactions between physical, real-world objects and synthetic, computer-generated objects are described herein. The techniques described herein increase processing speed and reduce computational resources to enable substantially real time super and sub-imposition of synthetic objects having realistic visibility within and/or interaction with physical, real-world scenes based in part on depth and location.

In at least one example, the techniques herein describe receiving a stream of depth data and a stream of color data associated with a real scene of an augmented reality display. The techniques herein further describe processing the stream of depth data to construct a first mesh and projecting the first mesh into a color space associated with the stream of color data to construct a second mesh. Based at least on constructing the second mesh, the techniques herein describe drawing one or more synthetic objects into the real scene. In some examples, the techniques herein describe determining a position of the one or more synthetic objects relative to one or more real objects in the real scene based at least in part on surface boundaries defined by the second mesh. In additional or alternative examples, the techniques herein describe performing one or more queries using the surface boundaries defined by the second mesh to determine how the one or more synthetic objects interact with the one or more real objects in the real scene. As a result, the techniques herein optimize augmented reality scenes by using the second mesh to draw synthetic objects in real scenes such that the synthetic objects interact with real objects in the real scene as if they were real objects.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

### DESCRIPTION OF FIGURES

The Detailed Description is described with reference to the accompanying figures. In the figures, the left-most digit(s) of a reference number identifies the figure in which the reference number first appears. The same reference numbers in different figures indicate similar or identical items.

FIG. 1 illustrates an example environment in which techniques for using depth information for drawing in augmented reality scenes may be performed.

FIG. 2 illustrates an example operating environment for using depth information for drawing in augmented reality scenes.

FIG. 3 illustrates an example process for using depth information for drawing in augmented reality scenes.

FIG. 4 illustrates another example process for using depth information for drawing in augmented reality scenes.

FIG. 5 illustrates yet another example process for using depth information for drawing in augmented reality scenes.

FIG. 6 illustrates yet another example process for using depth information for drawing in augmented reality scenes.

### DETAILED DESCRIPTION

Techniques for optimizing augmented reality scenes by using depth information to accurately display interactions between physical, real-world objects and synthetic, computer-generated objects in an augmented reality scene are described herein. Augmented reality is a technology that supplements a display of physical, real-world objects with computer-generated input such as sound, video, graphics, GPS, etc. For example, video games and other entertainment systems may supplement live video of physical, real-world objects with synthetic, computer-generated game characters and objects.

For the purposes of this discussion, physical, real-world objects (“real objects”) describe objects that physically exist in a field of view of a real-world scene (“real scene”) associated with an augmented reality display. Real objects may move in and out of the field of view based on movement patterns of the real objects and/or movement of a user and/or user device. Synthetic, computer-generated objects (“synthetic objects”) describe objects that are generated by one or more computing devices to supplement the real scene in the user's field of view. Synthetic objects may include computer-generated input such as sound, video, graphics, GPS, etc. Synthetic objects may be rendered into the augmented reality scene via techniques described herein.

Depth information from a real scene may be leveraged to optimize how synthetic objects interact with real objects in the real scenes within the field of view of an augmented reality display. Interactions may refer to visual interactions that refer to the visibility and/or occlusion of synthetic objects with respect to real objects in the real scene. In some examples, a synthetic object may be positioned behind a real object. Accordingly, the synthetic object may be at least partially occluded by the real object. That is, the synthetic object may be at least partially obstructed, blocked, and/or sub-imposed behind the real object. In other examples, a synthetic object may be positioned in front of a real object. As a result, the real object may be at least partially occluded by the synthetic object. That is, the synthetic object may at least partially obstruct and/or block the real object such that the synthetic object appears superimposed over the real object.

Additionally, interactions may refer to mechanical interactions such as collisions between synthetic objects and real objects in the real scene within the field of view of an augmented reality display. A collision occurs when portions of different, moving objects meet for a period of time. In some examples, a collision may describe a relatively dynamic interaction where different objects meet (e.g., real and/or synthetic), apply force to one another, and cause an exchange of energy resulting in the different objects noticeably changing their behaviors. In other examples, a collision may describe a relatively static interaction where different objects (e.g., real and/or synthetic) meet, apply force to one another, and cause an exchange of energy resulting in the different objects changing their behaviors in ways that are unnoticeable to the human eye.

The techniques herein describe increasing processing speed and reducing computational resources to enable substantially real time super and sub-imposition of synthetic objects having realistic visibility within and/or interaction with real scenes based on depth and location. In at least one example, the techniques herein describe receiving a stream of depth data associated with a real scene of an augmented reality display and receiving a stream of color data associated with the real scene. The techniques herein further describe processing the stream of depth data to construct a first mesh and projecting the first mesh into a color space associated with the stream of color data to construct a second mesh. Based at least on constructing the second mesh, the techniques herein describe drawing one or more synthetic objects into the real scene. In some examples, the techniques herein describe determining a position of the one or more synthetic objects respective to one or more real objects in the real scene. In additional or alternative examples, the techniques herein describe performing one or more queries to determine how the one or more synthetic objects interact with the one or more real objects in the real scene.

A user's experience may be enhanced as a result of optimizing augmented reality scenes by enabling substantially real time super and sub-imposition of synthetic objects having realistic visibility within and/or interaction with real scenes based on depth and location. For instance, a user may sit in his or her living room watching a scary movie, for example via a picture-in-picture presentation where the user may have an augmented reality view of him or herself and a view of the scary movie. Leveraging the techniques described herein, a synthetic spider could be inserted into the user's augmented reality view. The synthetic spider may crawl up from behind a chair that the user is sitting in and crawl over the user's shoulder. By supplementing the user's field of view of the scene with a realistically appearing and realistically interacting synthetic spider, the techniques described herein may enhance the user's viewing experience. In other examples, such as in an artificial combat scenario, a user may point and aim at objects or another user in a room and the techniques described herein may cause synthetic crosshairs to appear on the objects or the other user. The realistically appearing and/or interacting crosshairs can enhance the user's gaming experience.

In yet other examples, a user may leverage the techniques described herein for shopping via e-commerce web sites. For instance, a user may determine how various home decorating products look with his or her current home furnishings. If a user is shopping on an e-commerce website, he or she may select a vase and a synthetic vase may be drawn into the field of view of the real scene. As a result, the user may determine whether the vase complements his or her current home furnishings without having to purchase the vase. The realistically appearing and/or interacting products can enhance the user's e-commerce shopping experience.

### Illustrative Environment

The environments described below constitute but one example and are not intended to limit application of the system described below to any one particular operating environment. Other environments may be used without departing from the spirit and scope of the claimed subject matter. The various types of processing described herein may be implemented in any number of environments including, but not limited to, stand alone computing systems, network environments (e.g., local area networks or wide area networks), peer-to-peer network environments, distributed-computing (e.g., cloud-computing) environments, etc.

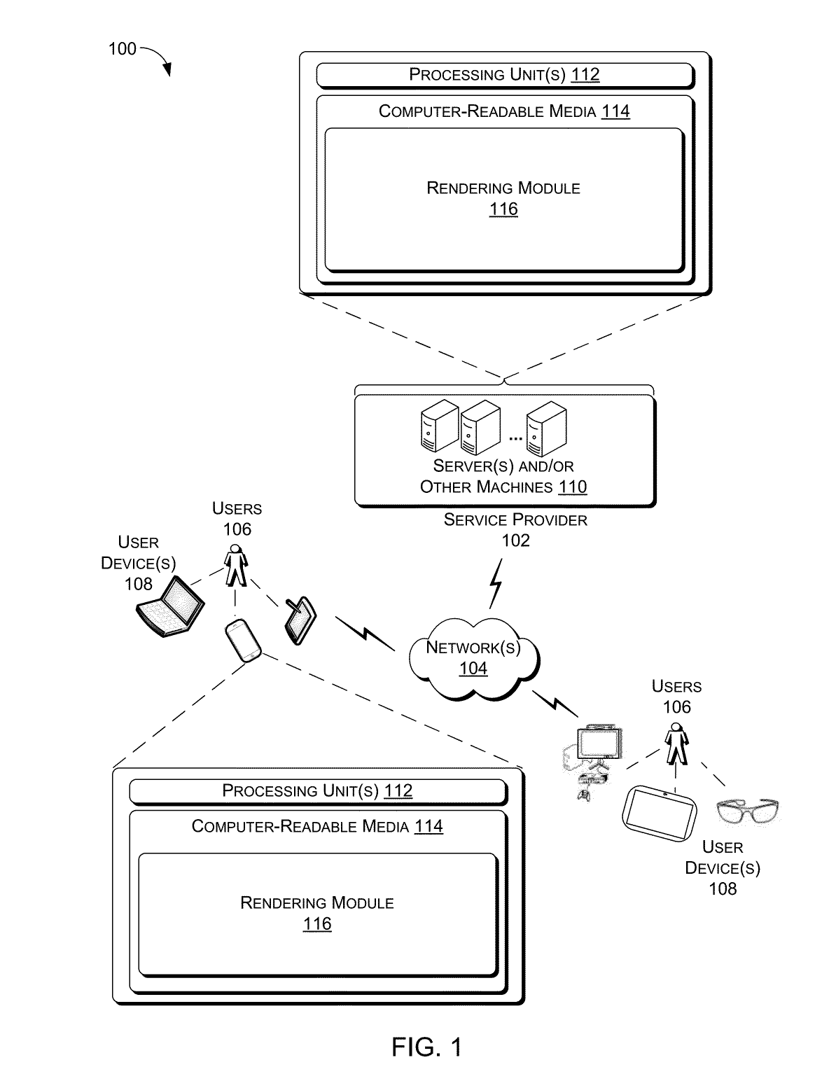

FIG. 1 illustrates an example environment 100 in which techniques for optimizing augmented reality scenes by using depth information to accurately display interactions between real objects and synthetic objects may be embodied. In at least one example, the techniques described herein may be performed remotely (e.g., by a server, cloud, etc.). In some examples, the techniques described herein may be performed locally on a user device as described below.

The example operating environment 100 may include a service provider 102, one or more network(s) 104, one or more users 106, and one or more user devices 108 associated with the one or more users 106. As shown, the service provider 102 may include one or more server(s) and/or other machines 110, any of which may include one or more processing unit(s) 112 and computer-readable media 114. In various webservice or cloud based embodiments, the service provider 102 may optimize augmented reality scenes by using depth information to accurately display interactions between real objects and synthetic objects in a real scene displayed in an augmented reality display.

In some embodiments, the network(s) 104 may be any type of network known in the art, such as the Internet. Moreover, the user devices 108 may communicatively couple to the network(s) 104 in any manner, such as by a global or local wired or wireless connection (e.g., local area network (LAN), intranet, etc.). The network(s) 104 may facilitate communication between the server(s) and/or other machines 110 and the user devices 108 associated with the users 106.

In some embodiments, the users 106 may operate corresponding user devices 108 to perform various functions associated with the user devices 108, which may include one or more processing unit(s) 112, computer-readable storage media 114, and a display. Furthermore, the users 106 may utilize the user devices 108 to communicate with other users 106 via the one or more network(s) 104.

User device(s) 108 may represent a diverse variety of device types and are not limited to any particular type of device. User device(s) 108 may include any type of computing device having one or more processing unit(s) 112 operably connected to computer-readable media 114 such as via a bus, which in some instances may include one or more of a system bus, a data bus, an address bus, a PCI bus, a Mini-PCI bus, and any variety of local, peripheral, and/or independent buses. Executable instructions stored on computer-readable media 114 may include, for example, rendering module 116 and other modules, programs, or applications that are loadable and executable by processing units(s) 112.

Examples of user device(s) 108 may include but are not limited to stationary computers, mobile computers, embedded computers, or combinations thereof. Example stationary computers may include desktop computers, work stations, personal computers, thin clients, terminals, game consoles, personal video recorders (PVRs), set-top boxes, or the like. Example mobile computers may include laptop computers, tablet computers, wearable computers, implanted computing devices, telecommunication devices, automotive computers, personal data assistants (PDAs), portable gaming devices, media players, cameras, or the like. Example embedded computers may include network enabled televisions, integrated components for inclusion in a computing device, appliances, microcontrollers, digital signal processors, or any other sort of processing device, or the like.

The service provider 102 may be any entity, server(s), platform, etc., that may leverage depth and image data to optimize augmented reality scenes by using the depth and image information to accurately display interactions between real objects and synthetic objects. Moreover, and as shown, the service provider 102 may include one or more server(s) and/or other machines 110, which may include one or more processing unit(s) 112 and computer-readable media 114 such as memory. The one or more server(s) and/or other machines 110 may include devices.

Examples support scenarios where device(s) that may be included in the one or more server(s) and/or other machines 110 may include one or more computing devices that operate in a cluster or other grouped configuration to share resources, balance load, increase performance, provide fail-over support or redundancy, or for other purposes. Device(s) included in the one or more server(s) and/or other machines 110 may belong to a variety of categories or classes of devices such as traditional server-type devices, desktop computer-type devices, mobile devices, special purpose-type devices, embedded-type devices, and/or wearable-type devices. Thus, although illustrated as server computers, device(s) may include a diverse variety of device types and are not limited to a particular type of device. Device(s) included in the one or more server(s) and/or other machines 110 may represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device.

Device(s) that may be included in the one or more server(s) and/or other machines 110 may include any type of computing device having one or more processing unit(s) 112 operably connected to computer-readable media 114 such as via a bus, which in some instances may include one or more of a system bus, a data bus, an address bus, a PCI bus, a Mini-PCI bus, and any variety of local, peripheral, and/or independent buses. Executable instructions stored on computer-readable media 114 may include, for example, rendering module 116, and other modules, programs, or applications that are loadable and executable by processing units(s) 112. Alternatively, or in addition, the functionality described herein may be performed, at least in part, by one or more hardware logic components or accelerators. For example, and without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator may represent a hybrid device, such as one from ZYLEX or ALTERA that includes a CPU course embedded in an FPGA fabric.

Device(s) that may be included in the one or more server(s) and/or other machines 110 may further include one or more input/output (I/O) interface(s) coupled to the bus to allow device(s) to communicate with other devices such as user input peripheral devices (e.g., a keyboard, a mouse, a pen, a game controller, a voice input device, a touch input device, gestural input device, an image camera, a depth sensor, and the like) and/or output peripheral devices (e.g., a display, a printer, audio speakers, a haptic output, and the like). Devices that may be included in the one or more server(s) and/or other machines 110 may also include one or more network interfaces coupled to the bus to enable communications between computing devices and other networked devices such as user device(s) 108. Such network interface(s) may include one or more network interface controllers (NICs) or other types of transceiver devices to send and receive communications over a network. For simplicity, some components are omitted from the illustrated devices.

Processing unit(s) 112 may represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that may be used include Application-Specific Integrated Circuits (ASICs), Application-Specific Standard Products (ASSPs), System-on-a-chip systems (SOCs), Complex Programmable Logic Devices (CPLDs), etc. In various embodiments, the processing unit(s) 112 may execute one or more modules and/or processes to cause the server(s) and/or other machines 110 to perform a variety of functions, as set forth above and explained in further detail in the following disclosure. Additionally, each of the processing unit(s) 112 may possess its own local memory, which also may store program modules, program data, and/or one or more operating systems.

In at least one configuration, the computer-readable media 114 of the server(s) and/or other machines 110 and/or the user devices 108 may include components that facilitate interaction between the service provider 102 and the users 106. For example, the computer-readable media 114 may include at least a rendering module 116 that may be implemented as computer-readable instructions, various data structures, and so forth via at least one processing unit(s) 112 to configure a device to execute instructions and to perform operations for optimizing augmented reality scenes by using depth information to accurately display interactions between physical, real-world objects and synthetic, computer-generated objects. Functionality to perform these operations may be included in multiple devices or a single device.

Depending on the exact configuration and type of the one or more server(s) and/or other machines 110 and/or the user device(s) 108, the computer-readable media 114 may include computer storage media and/or communication media. Computer storage media may include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that may be used to store and maintain information for access by a computing device.

In contrast, communication media includes computer readable instructions, data structures, program modules, or other data in a modulated data signal, such as a carrier wave, or other transmission mechanism. As defined herein, computer storage media does not include communication media.

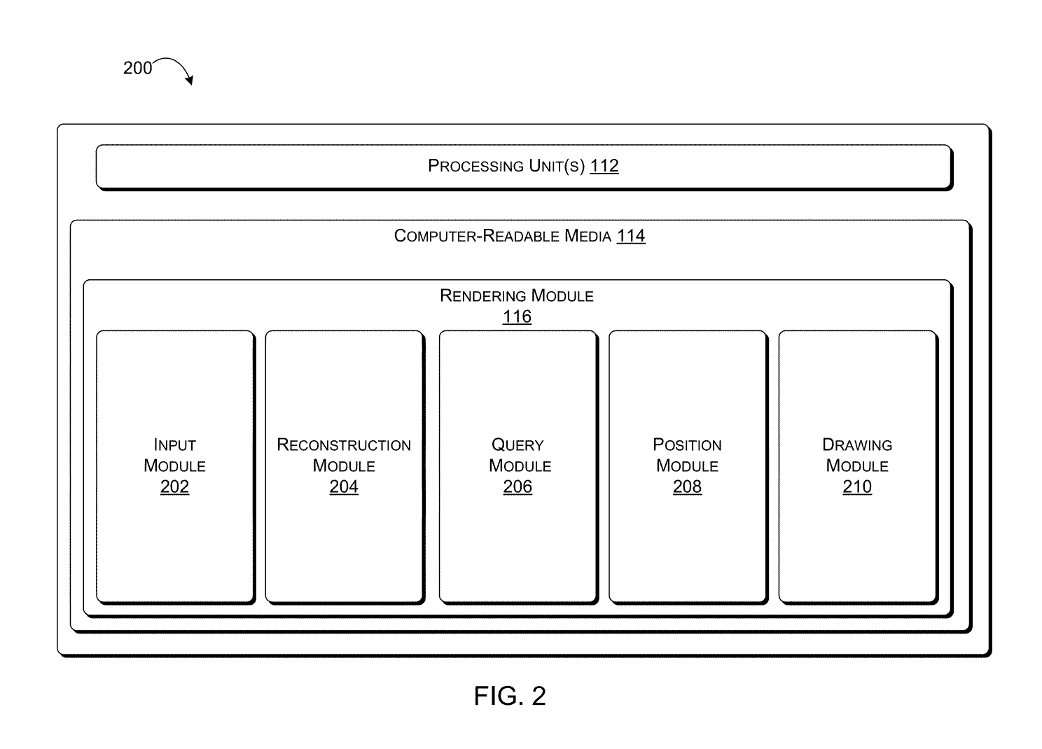

FIG. 2 illustrates an example operating environment 200 for optimizing augmented reality scenes by using depth information to accurately display interactions between real objects and synthetic objects in an augmented reality scene. Example operating environment 200 shows the computer-readable media 114 of FIG. 1 with additional detail. In at least one example, computer-readable media 114 may include the rendering module 116, as described above. In the at least one example, the rendering module 116 may include various modules and components for optimizing augmented reality scenes by using depth information to accurately display interactions between real objects and synthetic objects. In the at least one example, the rendering module 116 may include an input module 202, reconstruction module 204, query module 206, position module 208, and drawing module 210.

The input module 202 may be configured to receive input data based on the real scene and/or real objects from various devices associated with the one or more server(s) and/or other machines 110 and/or user devices 108. The input module 202 may be configured to receive input data from cameras and/or sensors associated with the one or more server(s) and/or other machines 110 and/or user devices 108. The cameras may include image cameras, stereoscopic cameras, trulight cameras, etc. The sensors may include depth sensors, color sensors, acoustic sensors, pattern sensors, gravity sensors, etc. In some examples, the cameras and/or sensors may be integrated into the one or more server(s) and/or other machines 110 and/or user devices 108. In other examples, the cameras and/or sensors may be peripheral to the one or more server(s) and/or other machines 110 and/or user devices 108. The cameras and/or sensors may be associated with a single device (e.g., Microsoft® Kinect®, Intel® Perceptual Computing SDK 2013, Leap Motion, etc.) or separate devices. The cameras and/or sensors may be situated in the same device or different devices such that the cameras and/or sensors are a predetermined distance apart (e.g., 5 cm, 6.5 cm, 10 cm, etc.).

The cameras and/or sensors may output streams of input data in substantially real time. The streams of input data may be received by the input module 202 in substantially real time, as described above. The input data may include moving image data and/or still image data representative of a real scene that is observable by the cameras and/or sensors. The streams of input data may include at least a stream of color data and at least a stream of depth data. In at least one example, the stream of color data can include a grid of red, blue, green (RGB) values that represent pixels of an image of the real scene that is visible by at least one camera. The image may be displayed on a screen or other display device as a grid of RGB values called a color space. The color space may represent the RGB values that correspond to the volume of space that is visible from the at least one camera.

The depth data may represent distances between real objects in a real scene observable by sensors and/or cameras and the sensors and/or cameras. The depth data may be based at least in part on infrared (IR) data, trulight data, stereoscopic data, light and/or pattern projection data, gravity data, acoustic data, etc. In at least one example, the stream of depth data may be derived from IR sensors (e.g., time of flight, etc.) and may be represented as a point cloud reflective of the real scene. The point cloud may represent a set of data points or depth pixels associated with surfaces of real objects and/or the real scene configured in a three-dimensional coordinate system. The depth pixels may be mapped into a grid. The grid of depth pixels may indicate how far real objects in the real scene are from the cameras and/or sensors. The grid of depth pixels that correspond to the volume of space that is observable from the cameras and/or sensors may be called a depth space.

In at least one example, the coordinates of the color space and the coordinates of the depth space may not overlap. The cameras configured to collect color data and the cameras and/or sensors configured to collect depth data may be set a predetermined distance apart. In at least one example, the cameras for collecting color data may have a first line of sight with respect to the real scene and the cameras and/or sensors for collecting depth data may have a second line of sight with respect to the real scene. As a result, the color space and the depth space may represent different views of the real scene such that the coordinates of the corresponding grids do not overlap. The difference between the first line of sight associated with the color data and the second line of sight associated with the depth data may represent a parallax error between the color data and the depth data. Additionally, the grids associated with the color data and the depth data may not have the same dimensions.

The input module 202 may provide the streams of data to the reconstruction module 204 for generating a mesh that may be rendered into a visibility buffer (z-buffer). The reconstruction module 202 may access the streams of data for processing. The reconstruction module 204 may map coordinates from color space and coordinates from the depth space into a same coordinate space (e.g., a mesh in color space) so that coordinates in the same coordinate space correspond to color pixels that may be seen on the display of the augmented reality scene. Individual depth pixels in the point cloud can be used to create a mesh. The mesh may include a detailed geometric (e.g., triangular, polygonal, etc.) model of various features of an environment in a three dimensional representation that is derived from the individual depth pixels in the point cloud. The reconstruction module 204 may leverage triangulation calculations between individual depth pixels in the point cloud to construct the mesh and the mesh may be mapped to a surface of one or more real objects in a real scene such to represent surface boundaries associated with the one or more real objects. The triangulation calculations may include triangle rasterization leveraging scanline algorithms, standard algorithms, Bresenham algorithms, Barycentric algorithms, etc. The reconstruction module 204 may process the point cloud across the grid from left to right and in a top to bottom sequence to generate the mesh. The mesh, however, may not be even and/or may have gaps between depth pixels determined by the triangulation calculations.

The reconstruction module 204 may interpolate depth data between depth pixels in the mesh based at least in part on projecting the mesh into the color space associated with the stream of color data. By fusing the mesh and the color space, the reconstruction module 204 may fill the gaps in the mesh and may transform the mesh. In at least one example, the reconstruction module 204 may transform the mesh by making adjustments to the mesh based on distances between the cameras and/or sensors associated with the one or more server(s) and/or other machines 110 and/or user devices 108 that may be used to collect the depth data and/or the color data. The reconstruction module 204 may further transform the mesh by adjusting the mesh based on variations in field of views associated with the cameras and/or sensors, distortions that may occur within the optics of the cameras and/or sensors, etc. As a result, the reconstruction module 204 may reconstruct surfaces associated with real objects that may map precisely to the real scene for defining surface boundaries associated with the real objects in the real scene.

In at least some examples, the depth data may be projected into the color space and then the reconstruction module 204 may leverage triangulation calculations (e.g., triangle rasterization leveraging scanline algorithms, standard algorithms, Bresenham algorithms, Barycentric algorithms, etc.) between individual depth pixels in the integrated depth space and color space to generate a transformed mesh. As a result of the reconstruction module 204 generating the transformed mesh by performing the triangulation calculations on the depth space fused with the color space, depth values may be interpolated to even out the mesh derived from the depth data and/or fill in any gaps in the mesh derived from the depth data. The reconstruction module 204 may render the transformed mesh into a visibility buffer (z-buffer) for rendering against real objects in the scene. The z-buffer can represent per-pixel floating point data for the z depth of each pixel rendered in the scene.

The reconstruction module 204 may generate the mesh and transformed mesh, and reconstruct the surfaces of real objects in substantially real time, creating a dynamic mesh. As the reconstruction module 204 receives the streams of data, the reconstruction module 204 may repeatedly create a mesh and project the mesh into the color space to transform the mesh for reconstructing surfaces associated with real objects in the real scene in substantially real time. The reconstruction module 204 may process the streams of data in a recurring loop such that every frame of data that is visible to the user via the augmented reality technology may reflect a substantially real time physical, real-world view.

The query module 206 may be configured to determine how synthetic objects mechanically interact with real objects in the real scene. The query module 206 may be configured to perform special queries against surface boundaries of the real object defined at least in part by the transformed mesh generated by the reconstruction module 204. In at least one example, the query module 206 may perform collision tests using the transformed mesh to determine how synthetic objects can mechanically interact with real objects. For instance, the query module 206 may determine how two objects can behave before, during, and after a collision between the two objects. In other examples, the query module 206 may determine surface angles or other geometric measures (e.g., sizes, contours, etc.) to determine how synthetic objects can mechanically interact with real objects. The results of the processing by the query module 206 enable the rendering module 116 to render synthetic objects in real scenes such that the synthetic objects mechanically interact with real objects in a realistic manner.

The position module 208 may be configured to determine how synthetic objects visually interact with real objects in the real scene. The position module 208 may determine the visibility of synthetic objects based on a position of the synthetic objects and real objects in a real scene. The position module 208 may determine the position of the synthetic objects and/or real objects based at least in part on the surface boundaries of the real objects defined by the transformed mesh generated by the reconstruction module 204. In some examples such as video games, the position module 208 may determine how to position the synthetic objects based on game logic. The position module 208 may determine whether a synthetic object is fully occluded or partially occluded behind a real object. If the synthetic object is occluded behind the real object, the synthetic object may be rendered such that the synthetic object is sub-imposed behind the real object. The position module 208 may determine whether a real object is fully occluded or partially occluded behind a synthetic object. If the real object is occluded behind the synthetic object, the synthetic object may be rendered such that the synthetic object is superimposed over the real object. Using the transformed mesh generated from depth data and location information, the visual interactions between synthetic objects and real objects in augmented reality scenes may appear more realistic.

The drawing module 210 may draw synthetic objects in the field of view of the user based at least in part on the output of the query module 206 and/or the position module 208. The rendering module 116 may render the real scene based at least in part on the streams of data described above. The drawing module 210 may leverage the output from the query module 206 for drawing synthetic objects in the field of view realistically interacting with real objects in the real scene. As described above, the query module 206 may determine how two objects may behave before, during, and after a collision between the two objects. In other examples, the query module 206 may determine surface angles or other geometric measures to determine how synthetic objects may interact with real objects. The results of the processing by the query module 206 enable the rendering module 116 to render synthetic objects in real scenes such that the synthetic objects interact with real objects in a realistic manner.

For instance, if a synthetic cat appears to be lying on the back of a real sofa, the results generated by the query module 206 may ensure that the impression of the sofa into the cat's belly is correctly shaped to optimize the interaction between the synthetic cat and the real sofa. In another example, if a user throws a synthetic ball against a real slanted wall, the results generated by the query module 206 may ensure that the synthetic ball bounces in a direction following collision with the real angled wall as a real ball would bounce. Or, if a synthetic bird appears to fly into a window of a real house, the query module 206 may determine how the synthetic bird collides with the real window (and eventually falls backward) so that the synthetic bird's collision with the real window has same characteristics as if a real bird collided with a real window.

The drawing module 210 may additionally or alternatively leverage the output from the position module 208 for drawing synthetic objects in the field of view realistically interacting with real objects in the real scene. Based at least in part on determining how to position the synthetic objects via the position module 208, the drawing module 210 may render the synthetic objects in the field of view with realistic visibility and/or occlusion in relation to the real objects. That is, if a synthetic object is behind a real object, the synthetic object may appear partially occluded by the real object or sub-imposed behind the real object. Or, if a synthetic object is in front of a real object, the synthetic object may partially occlude the real object or be superimposed over the real object. Using the transformed mesh generated by the reconstruction module 204, the drawing module 210 may draw the synthetic objects so that they look realistic in the user's field of view.

### Example Processes

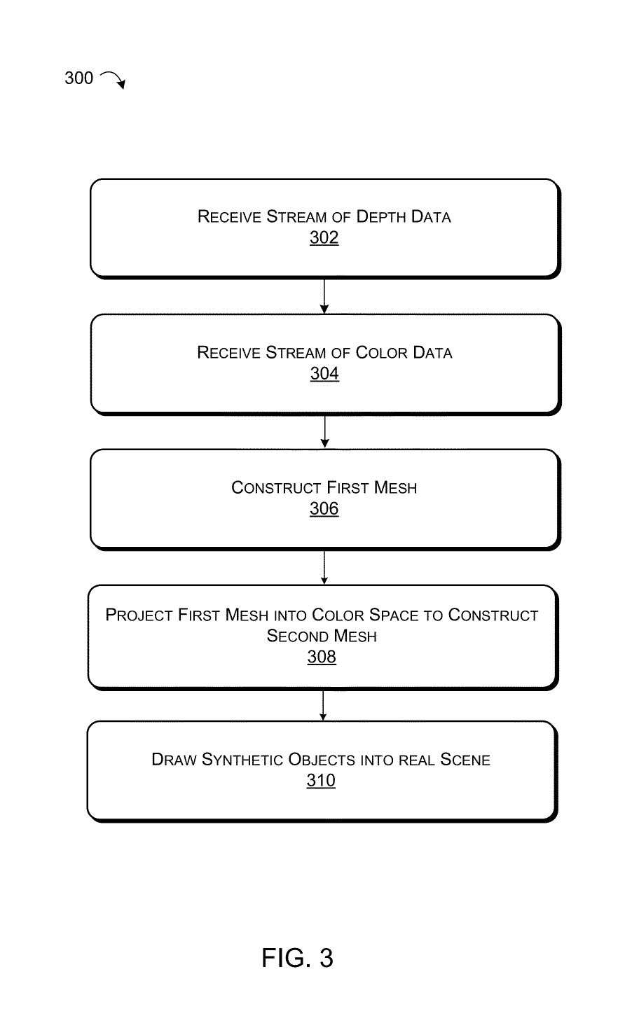

FIG. 3 illustrates a process 300 for using depth information for drawing in augmented reality scenes.

Block 302 illustrates receiving a stream of depth data. As described above, the input module 202 may be configured to receive input data representing the real scene and/or real objects from various devices associated with the one or more server(s) and/or other machines 110 and/or user devices 108. The input module 202 may receive the input data in two or more streams. At least one of the two or more streams may include a stream of depth data. The depth data may be based at least in part on IR data, trulight data, stereoscopic data, light and/or pattern projection data, gravity data, acoustic data, etc.

Block 304 illustrates receiving a stream of color data. As described above, the input module 202 may be configured to receive input data representing the real scene and/or real objects from various devices associated with the one or more server(s) and/or other machines 110 and/or user devices 108. At least a second of the two or more streams may include a stream of color data.

Block 306 illustrates constructing a first mesh. The reconstruction module 204 may access the stream of depth data and access the stream of color data. As described above, the reconstruction module 204 may map coordinates from the stream of color data and coordinates from the stream of depth data into a same coordinate space. The data in the stream of depth data may comprise a point cloud. The point cloud may be mapped into a grid. The reconstruction module 204 may extract the point cloud and leverage triangulation calculations to process the point cloud to construct a mesh that may be mapped to a surface of one or more real objects in a real scene. The reconstruction module 204 may process the point cloud across the grid from left to right and in a top to bottom sequence to generate the mesh.

Block 308 illustrates projecting the first mesh into a color space to construct a second mesh. As described above, the first mesh may not be even and/or may have gaps between depth pixels determined by the triangulation calculations. The reconstruction module 204 may interpolate depth data between depth pixels in the first mesh based at least in part on projecting the first mesh into a color space associated with the stream of color data. By fusing the first mesh and the color space, the reconstruction module 204 may fill the gaps in the first mesh and may create a second mesh, a transformed mesh. As a result, the reconstruction module 204 may reconstruct surfaces associated with real objects that may map precisely to the real scene.

Block 310 illustrates drawing synthetic objects in a real scene. The drawing module 210 may draw synthetic objects in the field of view of the user based at least in part on the transformed mesh. The rendering module 116 may render the real scene based at least in part on the streams of data described above. Based at least in part on determining how to synthetic objects interact in the real scene using the transformed mesh, the drawing module 210 may render the synthetic objects in the field of view with realistic visibility and/or occlusion in relation to the real objects and/or realistic interactions with the real objects.

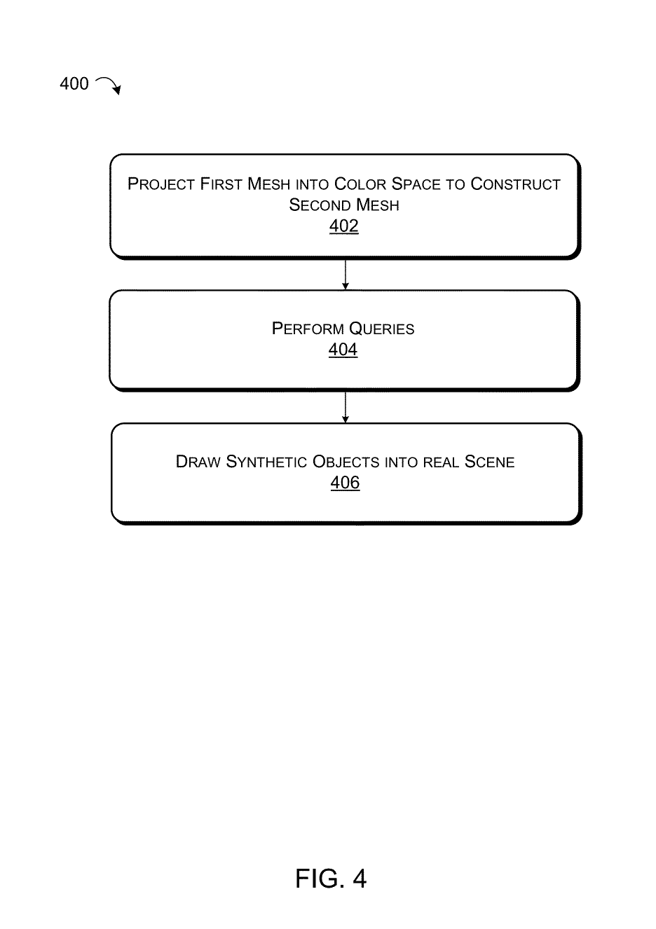

FIG. 4 illustrates another example process 400 for using depth information for drawing in augmented reality scenes. Process 400 may be integrated into process 300.

Block 402 illustrates projecting the first mesh into the color space to construct a second mesh. The first mesh described above may be called an incomplete mesh and the second mesh may be called a transformed mesh. As described above, the reconstruction module 204 may interpolate depth data between depth pixels in the incomplete mesh based at least in part on projecting the incomplete mesh into a color space associated with the stream of color data. By projecting the incomplete mesh into the color space, the reconstruction module 204 may fill the gaps in the incomplete mesh and may create the transformed mesh. As a result, the reconstruction module 204 may reconstruct surfaces associated with real objects that may map precisely to the real scene.

Block 404 illustrates performing queries. The query module 206 may be configured to perform queries against real objects in the scene based at least in part on the transformed mesh generated by the reconstruction module 204, as described above. In at least one example, the query module 206 may perform collision tests using the transformed mesh to determine how synthetic objects may mechanically interact with real objects. For instance, the query module 206 may determine how two objects may behave before, during, and after a collision between the two objects. In other examples, the query module 206 may determine surface angles or other geometric measures to determine how synthetic objects may mechanically interact with real objects. The results of the processing by the query module 206 enable the rendering module 116 to render synthetic objects in real scenes such that the synthetic objects interact with real objects in a realistic manner.

Block 406 illustrates drawing synthetic objects into a real scene. The drawing module 210 may draw synthetic objects in the field of view of the user based at least in part on determining how synthetic objects interact with real objects in the real scene, as described above.

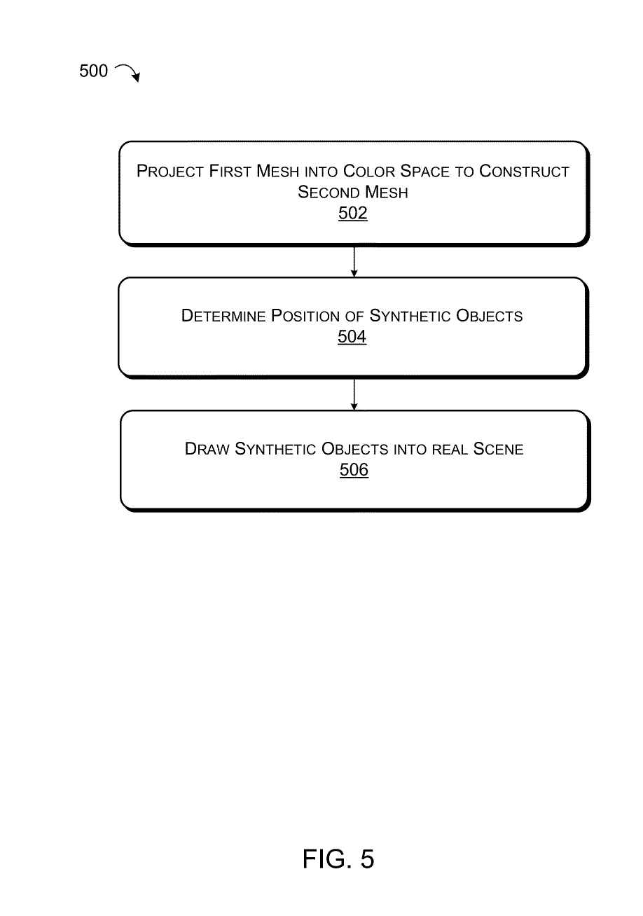

FIG. 5 illustrates yet another example process 500 for using depth information for drawing in augmented reality scenes. Process 500 may be integrated into processes 300 and/or 400.

Block 502 illustrates projecting the first mesh into the color space to construct the second mesh. The first mesh described above may be called an incomplete mesh and the second mesh may be called a transformed mesh. As described above, the reconstruction module 204 may interpolate depth data between depth pixels in the incomplete mesh based at least in part on projecting the incomplete mesh into a color space associated with the stream of color data. By projecting the incomplete mesh into the color space, the reconstruction module 204 may fill the gaps in the incomplete mesh and may create the transformed mesh. As a result, the reconstruction module 204 may reconstruct surfaces associated with real objects that may map precisely to the real scene.

Block 504 illustrates determining a position of synthetic objects. The position module 208 may be configured to determine how synthetic objects visually interact with real objects in the real scene. The position module 208 may determine the position of the synthetic objects based at least in part on the transformed mesh generated by the reconstruction module 204, as described above.

Block 506 illustrates drawing synthetic objects into a real scene. The drawing module 210 may draw synthetic objects in the field of view of the user based at least in part on determining how to position the synthetic objects relative to real objects in the real scene, as described above.

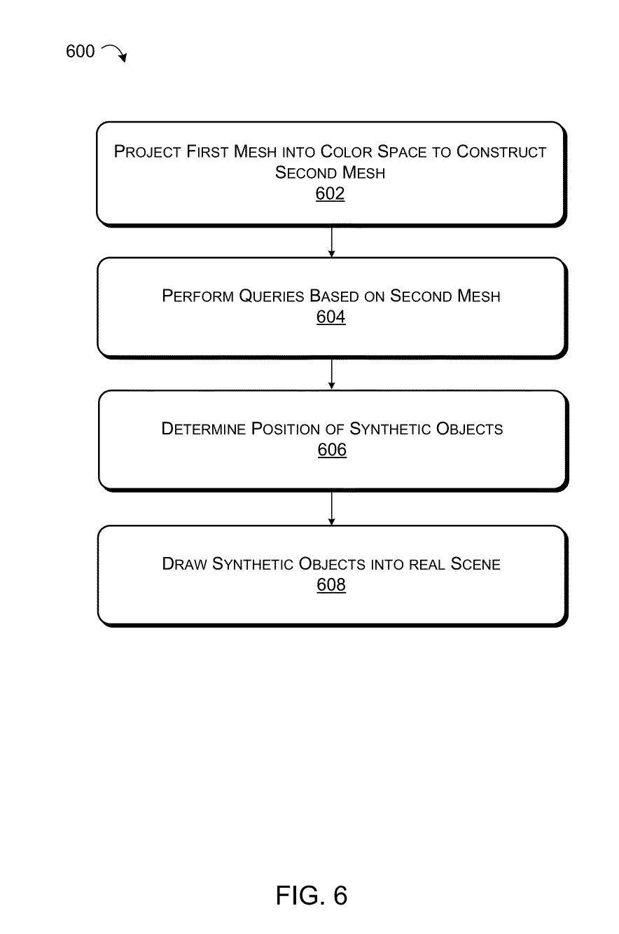

FIG. 6 illustrates yet another example process 600 for using depth information for drawing in augmented reality scenes. Process 600 may be integrated into process 300.

Block 602 illustrates projecting a first mesh into the color space to construct a second mesh. The first mesh described above may be called an incomplete mesh and the second mesh may be called a transformed mesh. As described above, the reconstruction module 204 may interpolate depth data between depth pixels in the incomplete mesh based at least in part on projecting the incomplete mesh into a color space associated with the stream of color data. By projecting the incomplete mesh into the color space, the reconstruction module 204 may fill the gaps in the incomplete mesh and may create the transformed mesh. As a result, the reconstruction module 204 may reconstruct surfaces associated with real objects that may map precisely to the real scene.

Block 604 illustrates performing queries. The query module 206 may be configured to perform special queries against real objects in the scene based at least in part on the transformed mesh generated by the reconstruction module 204, as described above.

Block 606 illustrates determining a position of synthetic objects. The position module 208 may determine the position of the synthetic objects based at least in part on the transformed mesh generated by the reconstruction module 204, as described above.

Block 608 illustrates drawing synthetic objects into a real scene. The drawing module 210 may draw synthetic objects in the field of view of the user based at least in part on leveraging the transformed mesh to determine how synthetic objects interact with real objects visually and/or mechanically. The rendering module 116 may render the real scene based at least in part on the streams of data described above. Based at least in part on determining how to synthetic objects interact in the real scene based on the transformed mesh, the drawing module 210 may render the synthetic objects in the field of view with realistic visibility and/or occlusion in relation to the real objects and/or realistic interactions with the real objects.

A. A computer-implemented method comprising: receiving a stream of depth data associated with a real scene of an augmented reality display; receiving a stream of color data associated with the real scene; processing the stream of depth data to construct a first mesh; projecting the first mesh into a color space associated with the stream of color data to construct a second mesh; and drawing one or more synthetic objects into the real scene based at least in part on boundaries of real objects in the real scene that are defined by the second mesh.

B. A computer-implemented method as paragraph A recites, wherein: the stream of depth data comprises a point cloud; and processing the stream of depth data comprises performing triangulation calculations between individual depth pixels in the point cloud to construct the first mesh.

C. A computer-implemented method as any of paragraphs A or B recite, wherein the second mesh maps precisely to the real scene.

D. A computer-implemented method as any of paragraphs A-C recite, further comprising rendering the second mesh into a visibility buffer for rendering against one or more real objects in the real scene.

E. A computer-implemented method as any of paragraphs A-D recite, wherein the processing the stream of depth data to construct the first mesh and the projecting the first mesh into the color space to construct the second mesh are performed in a recurring loop to construct a dynamic mesh that is reflective of the real scene in substantially real time.

F. A computer-implemented method as any of paragraphs A-E recite, further comprising performing one or more queries to determine how the one or more synthetic objects interact with one or more real objects in the real scene.

G. A computer-implemented method as paragraph F recites, wherein the one or more queries include: collision queries to determine how the one or more synthetic objects interact with the one or more real objects before, during, and after a collision between the any one or more synthetic objects and any one of the one or more real objects; and geometric queries to determine surface angles of the one or more real objects and/or contours of the one or more real objects.

H. A computer-implemented method as any of paragraphs A-G recite further comprising determining a visibility of a particular synthetic object of the one or more synthetic objects in the real scene based at least in part on the boundaries defined by the second mesh.

I. A computer-implemented method as paragraph H recites, wherein determining the visibility comprises: determining that the particular synthetic object is positioned at least partially behind one of the one or more real objects in the real scene; and drawing the particular synthetic object so that it is at least partially occluded behind the one of the one or more real objects in the real scene.

J. One or more computer-readable media encoded with instructions that, when executed by a processor, configure a computer to perform a method as recited in any of paragraphs A-I.

K. A device comprising one or more processors and one or more computer readable media encoded with instructions that, when executed by the one or more processors, configure a computer to perform a computer-implemented method as recited in any one of paragraphs A-I.

L. A system comprising: means for receiving a stream of depth data associated with a real scene of an augmented reality display; means for receiving a stream of color data associated with the real scene; means for processing the stream of depth data to construct a first mesh; means for projecting the first mesh into a color space associated with the stream of color data to construct a second mesh; and means for drawing one or more synthetic objects into the real scene based at least in part on boundaries of real objects in the real scene that are defined by the second mesh.

M. A system as paragraph L recites, wherein: the stream of depth data comprises a point cloud; and processing the stream of depth data comprises performing triangulation calculations between individual depth pixels in the point cloud to construct the first mesh.

N. A system as any of paragraphs L or M recite, wherein the second mesh maps precisely to the real scene.

O. A system as any of paragraphs L-N recite, further comprising means for rendering the second mesh into a visibility buffer for rendering against one or more real objects in the real scene.

P. A system as any of paragraphs L-O recite, wherein the processing the stream of depth data to construct the first mesh and the projecting the first mesh into the color space to construct the second mesh are performed in a recurring loop to construct a dynamic mesh that is reflective of the real scene in substantially real time.

Q. A system as any of paragraphs L-P recite, further comprising means for performing one or more queries to determine how the one or more synthetic objects interact with one or more real objects in the real scene.

R. A system as paragraph Q recites, wherein the one or more queries include: collision queries to determine how the one or more synthetic objects interact with the one or more real objects before, during, and after a collision between the any one or more synthetic objects and any one of the one or more real objects; and geometric queries to determine surface angles of the one or more real objects and/or contours of the one or more real objects.

S. A system as any of paragraphs L-R recite, further comprising means for determining a visibility of a particular synthetic object of the one or more synthetic objects in the real scene based at least in part on the boundaries defined by the second mesh.

T. A system as paragraph S recites, wherein the means for determining the visibility include means for determining that the particular synthetic object is positioned at least partially behind one of the one or more real objects in the real scene; and means for drawing the particular synthetic object so that it is at least partially occluded behind the one of the one or more real objects in the real scene.

U. A system comprising: computer-readable media storing at least a rendering module; a processing unit operably coupled to the computer-readable media, the processing unit adapted to execute at least the rendering module, the rendering module comprising: an input module for receiving at least two data streams associated with one or more real objects in a real scene, wherein a first data stream of the at least two data streams includes a depth data stream and a second data stream of the at least two data streams includes a color data stream; a reconstruction module for constructing a mesh defining surfaces associated with the one or more real objects in the real scene, the constructing based at least in part on projecting the depth data from the first data stream into color data from the second data stream; and a drawing module for drawing one or more synthetic objects into the real scene based at least in part on boundaries of the one or more real objects that are defined by the mesh.

V. As system as paragraph U recites, further comprising position module for determining how to position the one or more synthetic objects in the real scene based at least in part on the boundaries of the one or more real objects that are defined by the mesh, wherein positioning the one or more synthetic objects comprises: determining that the one or more synthetic objects are positioned behind the one or more real objects and partially occluding the one or more synthetic objects behind the one or more real objects; and determining that the one or more real objects are positioned behind the one or more synthetic objects and partially occluding the one or more real objects behind the one or more synthetic objects.

W. A system as any of paragraphs U or V recite, further comprising a query module for performing queries against the one or more real objects in the real scene to determine how the one or more synthetic objects interact with the one or more real objects, the queries based at least in part on the boundaries of the one or more real objects that are defined by the mesh.

X. A system as paragraph W recites, wherein the queries comprise collision queries to determine how the one or more synthetic objects and the one or more real objects interact responsive to one of the one or more synthetic objects colliding with one of the one or more real objects.

Y. A system as paragraph W recites, wherein the queries comprise geometric queries to determine at least an angle, contour, or size of the one or more real objects.

Z. A system as any of paragraphs U-Y recite, wherein the mesh comprises a transformed mesh, and constructing the transformed mesh comprises: extracting a point cloud from the stream of depth data; processing the point cloud using triangulation calculations to construct a first mesh that is mapped to a surface of the one or more real objects; projecting the first mesh into a color space associated with the stream of color data; and interpolating depth data between depth pixels in the first mesh to construct the transformed mesh.

AA. A system as paragraph Z recites, wherein the reconstruction module constructs the transformed mesh in substantially real time.

BB. One or more computer-readable media encoded with instructions that, when executed by a processor, configure a computer to perform acts comprising: receive depth data comprising a plurality of depth pixels arranged in a point cloud representative of a real scene of an augmented reality display; receive a stream of color data associated with the real scene; construct a mesh based at least in part on the plurality of depth pixels; update the mesh based at least in part on projecting the mesh into a color space associated with the stream of color data; and draw at least one synthetic object into the real scene based at least in part on surface boundaries defined by the mesh.

CC. One or more computer-readable media as paragraph BB recites, wherein the acts further comprise: determining a position of the at least one synthetic object with respect to one or more real objects in the real scene based at least in part on the surface boundaries defined by the mesh; based at least in part on determining that the at least one synthetic object is positioned behind the one or more real objects, drawing the at least one synthetic object sub-imposed over the one or more real objects; based at least in part on determining that the at least one synthetic object is positioned in front of the one or more real objects, drawing the at least one synthetic object superimposed in front of the one or more real objects.

DD. One or more computer-readable media as any of paragraphs BB or CC recite, wherein the acts further comprise performing one or more queries to determine how the at least one synthetic object interacts with one or more real objects in the real scene.

EE. One or more computer-readable media as paragraph DD recites, wherein the one or more queries include collision queries to determine how the at least one synthetic object interact with the one or more real objects before, during, and after a collision between the at least one synthetic object and any one of the one or more real objects; and geometric queries to determine surface angles of the one or more real objects and/or contours of the one or more real objects.

FF. One or more computer-readable media as any of paragraphs BB-EE recite, wherein constructing the mesh based at least in part on the plurality of depth pixels and updating the mesh based at least in part on projecting the mesh into a color space associated with the stream of color data are performed on a frame by frame basis so that every frame of the augmented reality display reflects a substantially real time physical, real-world view.

GG. A device comprising one or more processors and one or more computer readable media as recited in any of paragraphs BB-GG.

### CONCLUSION

In closing, although the various embodiments have been described in language specific to structural features and/or methodical acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method comprising:
receiving a stream of depth data associated with a real scene of an augmented reality display;
receiving a stream of color data associated with the real scene;
processing the stream of depth data to construct a first mesh;
projecting the first mesh into a color space associated with the stream of color data to construct a second mesh; and
drawing one or more synthetic objects into the real scene based at least in part on boundaries of real objects in the real scene that are defined by the second mesh.

2. The computer-implemented method of claim 1, wherein:
the stream of depth data comprises a point cloud; and
processing the stream of depth data comprises performing triangulation calculations between individual depth pixels in the point cloud to construct the first mesh.

3. The computer-implemented method of claim 1, wherein the second mesh maps precisely to the real scene.

4. The computer-implemented method of claim 1, further comprising rendering the second mesh into a visibility buffer for rendering against one or more real objects in the real scene.

5. The computer-implemented method of claim 1, wherein the processing the stream of depth data to construct the first mesh and the projecting the first mesh into the color space to construct the second mesh are performed in a recurring loop to construct a dynamic mesh that is reflective of the real scene in substantially real time.

6. The computer-implemented method of claim 1, further comprising performing one or more queries to determine how the one or more synthetic objects interact with one or more real objects in the real scene.

7. The computer-implemented method of claim 6, wherein the one or more queries include:
collision queries to determine how the one or more synthetic objects interact with the one or more real objects before, during, and after a collision between the any one or more synthetic objects and any one of the one or more real objects; and
geometric queries to determine surface angles of the one or more real objects and/or contours of the one or more real objects.

8. The computer-implemented method of claim 1, further comprising determining a visibility of a particular synthetic object of the one or more synthetic objects in the real scene based at least in part on the boundaries defined by the second mesh.

9. The computer-implemented method of claim 8, wherein determining the visibility comprises:
determining that the particular synthetic object is positioned at least partially behind one of the one or more real objects in the real scene; and
drawing the particular synthetic object so that it is at least partially occluded behind the one of the one or more real objects in the real scene.

10. A system comprising:
computer-readable media storing at least a rendering module;
a processing unit operably coupled to the computer-readable media, the processing unit adapted to execute at least the rendering module, the rendering module comprising:
an input module for receiving at least two data streams associated with one or more real objects in a real scene, wherein a first data stream of the at least two data streams includes a depth data stream and a second data stream of the at least two data streams includes a color data stream;
a reconstruction module for constructing a mesh defining surfaces associated with the one or more real objects in the real scene, the constructing based at least in part on projecting the depth data from the first data stream into color data from the second data stream; and
a drawing module for drawing one or more synthetic objects into the real scene based at least in part on boundaries of the one or more real objects that are defined by the mesh.

11. The system of claim 10, further comprising position module for determining how to position the one or more synthetic objects in the real scene based at least in part on the boundaries of the one or more real objects that are defined by the mesh, wherein positioning the one or more synthetic objects comprises:
determining that the one or more synthetic objects are positioned behind the one or more real objects and partially occluding the one or more synthetic objects behind the one or more real objects; and
determining that the one or more real objects are positioned behind the one or more synthetic objects and partially occluding the one or more real objects behind the one or more synthetic objects.

12. The system of claim 10, further comprising a query module for performing queries against the one or more real objects in the real scene to determine how the one or more synthetic objects interact with the one or more real objects, the queries based at least in part on the boundaries of the one or more real objects that are defined by the mesh.

13. The system of claim 12, wherein the queries comprise collision queries to determine how the one or more synthetic objects and the one or more real objects interact responsive to one of the one or more synthetic objects colliding with one of the one or more real objects.

14. The system of claim 12, wherein the queries comprise geometric queries to determine at least an angle, contour, or size of the one or more real objects.

15. The system of claim 10, wherein the mesh comprises a transformed mesh, and constructing the transformed mesh comprises:
extracting a point cloud from the stream of depth data;
processing the point cloud using triangulation calculations to construct a first mesh that is mapped to a surface of the one or more real objects;
projecting the first mesh into a color space associated with the stream of color data; and
interpolating depth data between depth pixels in the first mesh to construct the transformed mesh.

16. The system of claim 15, wherein the reconstruction module constructs the transformed mesh in substantially real time.

17. One or more computer-readable media encoded with instructions that, when executed by a processor, configure a computer to perform acts comprising:
receive depth data comprising a plurality of depth pixels arranged in a point cloud representative of a real scene of an augmented reality display;
receive a stream of color data associated with the real scene;
construct a mesh based at least in part on the plurality of depth pixels;
update the mesh based at least in part on projecting the mesh into a color space associated with the stream of color data; and
draw at least one synthetic object into the real scene based at least in part on surface boundaries defined by the mesh.

18. One or more computer-readable media as claim 17 recites, wherein the acts further comprise:
determining a position of the at least one synthetic object with respect to one or more real objects in the real scene based at least in part on the surface boundaries defined by the mesh;
based at least in part on determining that the at least one synthetic object is positioned behind the one or more real objects, drawing the at least one synthetic object sub-imposed over the one or more real objects;
based at least in part on determining that the at least one synthetic object is positioned in front of the one or more real objects, drawing the at least one synthetic object superimposed in front of the one or more real objects.

19. One or more computer-readable media as claim 18 recites, wherein the acts further comprise performing one or more queries to determine how the at least one synthetic object interacts with one or more real objects in the real scene.

20. One or more computer-readable media as claim 17 recites, wherein constructing the mesh based at least in part on the plurality of depth pixels and updating the mesh based at least in part on projecting the mesh into a color space associated with the stream of color data are performed on a frame by frame basis so that every frame of the augmented reality display reflects a substantially real time physical, real-world view.
